(19) United States
(12) Patent Application Publication
(10) Pub. No.: US 2019/0172345 A1
(43) Pub. Date: Jun. 6, 2019

(54) SYSTEM AND METHOD FOR DETECTING DANGEROUS VEHICLE

(71) Applicant: Institute for Information Industry, Taipei (TW)

(72) Inventors: Chi-Sheng LIN, Taipei City (TW); Chien LEE, Taipei City (TW); Wei-Lun HSIAO, Taipei City (TW); Yu-Ting HSU, New Taipei City (TW)

(21) Appl. No.: 15/834,032

(22) Filed: Dec. 6, 2017

(30) Foreign Application Priority Data
Dec. 4, 2017 (TW) 106142420

(51) Int. Cl. G08G 1/017; G08G 1/01; G08G 1/015

(52) U.S. Cl. CPC G08G 1/0175; G08G 1/0133; G08G 1/015; G08G 1/0116

(57) ABSTRACT

The present disclosure provides a system and a method for detecting a dangerous vehicle. This method includes steps as follows. Vehicle detectors spaced apart from each other are provided, and each vehicle detector obtains a traffic image. The server infers the interaction among the vehicles in the traffic image according to a car-following theory, so as to find at least one outlier vehicle from the vehicles and to select the outlier vehicle as a focus vehicle to be tracked. The server determines whether the driving behavior of the focus vehicle falls into an abnormal behavior model.

### RELATED APPLICATIONS

This application claims priority to Taiwan Patent Application No. 106142420, filed Dec. 4, 2017, the entirety of which is herein incorporated by reference.

### BACKGROUND

### Field of Invention

The present disclosure relates to the apparatuses and methods, and more particularly, systems and methods for detecting dangerous vehicles.

### Description of Related Art

The motor vehicle is provided by an engine or motor, usually by an internal combustion engine. The motor vehicle mainly refers to the vehicles on the road. Motor vehicles move fast, they are important regulatory traffic objects in the world.

However, in the past, the evaluation of the driving behavior is only focused on the characteristics of a single vehicle, but the characteristics of the road are varied, it was easy to make a mistake in evaluation considering only the characteristics of the single vehicle. Moreover, in the past, it was a one-time monitoring of all vehicles and therefore a system overload problem occurs.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one or more various aspects, the present disclosure is directed to systems and methods for detecting dangerous vehicles.

An embodiment of the present disclosure is related to a system includes a plurality of vehicle detectors and a server, and the server is communicated with the vehicle detectors. The vehicle detectors are spaced apart from each other, and each vehicle detector configured to obtain a traffic image. The server is configured to infer an interaction among vehicles in the traffic image according to a car-following theory, so as to find at least one outlier vehicle from the vehicles and to select the outlier vehicle as a focus vehicle to be tracked, and the server configured to determine whether a driving behavior of the focus vehicle falls into an abnormal behavior model.

In one embodiment, the server determines a size and a moving direction of focus area surroundings the focus vehicle required to be detected according to a direction, a speed and a position of the focus vehicle.

In one embodiment, the server recognizes types of the vehicles 141, 142 and 143 from the traffic image.

In one embodiment, the server collects driving track data of the vehicles from the traffic image.

In one embodiment, the abnormal behavior model comprises a violation condition of a plurality of traffic rules, and when the server determines that the driving behavior of the focus vehicle violates at least one of the traffic rules, the server determines that the focus vehicle is abnormal.

In one embodiment, the abnormal behavior model comprises at least one abnormal track, when the server determines that a driving track of the focus vehicle is different from driving tracks of others of the vehicles, and when the driving track of the focus vehicle meets the at least one abnormal track, the server determines that the focus vehicle is abnormal.

In one embodiment, the abnormal behavior model includes at least one abnormal speed difference range, the server compares a speed of the focus vehicle with an average speed of others of the vehicles, and when a speed difference between the driving speed of the focus vehicle and the average driving speed falls within the at least one abnormal speed difference range, the server determines that the focus vehicle is abnormal.

In one embodiment, the abnormal behavior model includes at least one abnormal distance, and when the server determines that a distance between the focus vehicle and any of others of the vehicles is less than the at least one abnormality distance, the server determines that the focus vehicle is abnormal.

In one embodiment, the server performs an alert processing procedure after the driving behavior of the focus vehicle has fallen into the abnormal behavior model.

In one embodiment, wherein each of the vehicle detectors is a roadside camera.

Another embodiment of the present disclosure is related to a method for detecting dangerous vehicle includes steps of: providing a plurality of vehicle detectors spaced apart from each other, and each vehicle detector configured to obtain a traffic image; using a server configured to infer an interaction among vehicles in the traffic image according to a car-following theory, so as to find at least one outlier vehicle from the vehicles and to select the outlier vehicle as a focus vehicle to be tracked, and the server configured to determine whether a driving behavior of the focus vehicle falls into an abnormal behavior model.

In one embodiment, the method further includes steps of: using the server to determine a size and a moving direction of a focus area surroundings the focus vehicle required to be detected according to a direction, a speed and a position of the focus vehicle.

In one embodiment, the method further includes steps of: using the server to recognize types of the vehicles from the traffic image.

In one embodiment, the method further includes steps of: using the server to collect driving track data of the vehicles from the traffic image.

In one embodiment, the abnormal behavior model comprises a violation condition of a plurality of traffic rules, and the method further includes steps of: when the server determines that the driving behavior of the focus vehicle violates at least one of the traffic rules, determining that the focus vehicle is abnormal by using the server.

In one embodiment, the abnormal behavior model comprises at least one abnormal track, and the method further includes steps of: when the server determines that a driving track of the focus vehicle is different from driving tracks of others of the vehicles, and when the driving track of the focus vehicle meets the at least one abnormal track, determining that the focus vehicle is abnormal by using the server.

In one embodiment, the abnormal behavior model includes at least one abnormal speed difference range, and the method further includes steps of: using the server compares a speed of the focus vehicle with an average speed of others of the vehicles; when a speed difference between the driving speed of the focus vehicle and the average driving speed falls within the at least one abnormal speed difference range, determining that the focus vehicle is abnormal by using the server.

In one embodiment, the abnormal behavior model includes at least one abnormal distance, and the method further includes steps of: when the server determines that a distance between the focus vehicle and any of others of the vehicles is less than the at least one abnormality distance, the server determines that the focus vehicle is abnormal.

In one embodiment, the method further includes steps of: using the server performs an alert processing procedure after the driving behavior of the focus vehicle has fallen into the abnormal behavior model.

In one embodiment, each of the vehicle detectors is a roadside camera.

Technical advantages are generally achieved, by embodiments of the present invention. The system and the method for detecting the dangerous vehicle provide the vehicle dynamic focus image recognition, so as to accomplish accurate and comprehensive consideration of the warning mode.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1A is a block diagram of a system for detecting a dangerous vehicle according to one embodiment of the present disclosure;

FIG. 1B is a block diagram of a system for detecting a dangerous vehicle according to another embodiment of the present disclosure;

FIG. 2 is a schematic diagram of a focus area according to one embodiment of the present disclosure; and

FIG. 3 is a flow chart of a method for detecting a dangerous vehicle according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

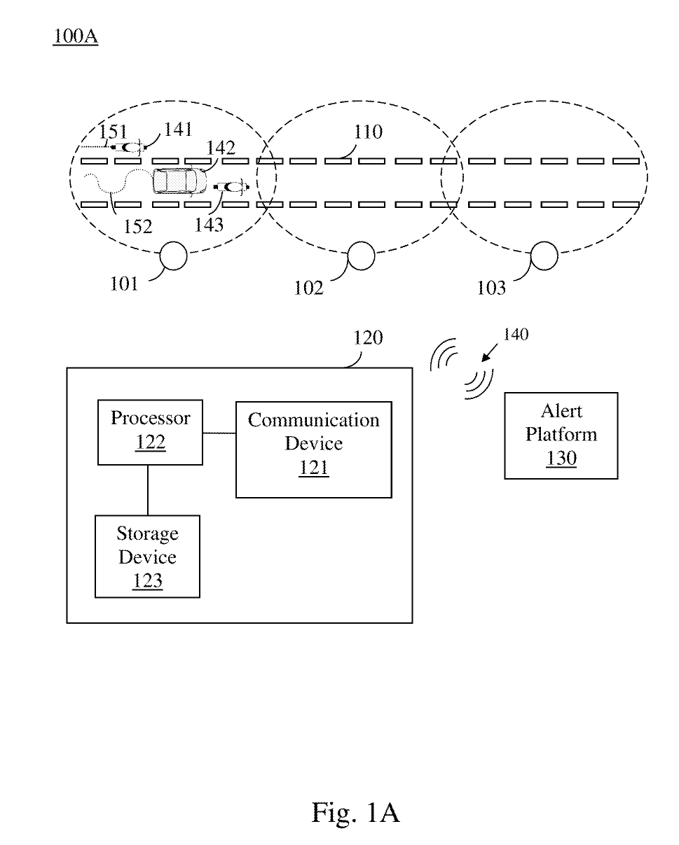

FIG. 1A is a block diagram of a system 100A for detecting a dangerous vehicle according to one embodiment of the present disclosure. As shown in FIG. 1A, the system 100A includes a plurality of vehicle detectors 101, 102 and 103 and a server 120. In structure, the server 120 is communicated with the vehicle detectors 101, 102 and 103. In another embodiment, the system 100 further includes an alert platform 130, and the server 120 is communicated with the alert platform 130. In one embodiment, the communication 140 is established among the system 100, vehicle detectors 101, 102 and 103 and/or the alert platform 130 in a wired or wireless manner, such as Wi-Fi wireless communication or wired network communication.

In practice, the server 120 may be a cloud server. The alert platform 130 may be a host computer of local unit, a traffic control unit, or the police. The plurality of vehicle detectors 101, 102 and 103 are arranged at a fixed spacing from each other or non-fixed spacing from each other. For example, the vehicle detectors 101, 102, and 103 are all roadside cameras and are spaced apart from each other on a street lamp, a dividing island or a roadside of a sidewalk, or the vehicle detectors 101, 102, and 103 are all aerial cameras. Alternatively, one or more of the vehicle detectors 101, 102 and 103 may be roadside cameras, and the other may be aerial cameras. Those with ordinary skill in the art may flexibly design the vehicle detectors depending on the desired application.

In FIG. 1A, the server 120 may include a communication device 121, a processor 122, and a storage device 123. The communication device 121 (e.g., a wired or wireless network device) to establish communications 140 with the vehicle detectors 101, 102 and 103 and/or the alert platform 130. The storage device 123 (e.g., a hard disk) can be used to preload an abnormal behavior model of the vehicle and record traffic images acquired by the vehicle detectors 101, 102 and 103. Accordingly, the processor 122 (e.g., a central processing unit) can detect a dangerous vehicle.

Specifically, in system 100A, each vehicle detector (e.g., the vehicle detector 101) configured to obtain the traffic image. The server 120 is configured to infer an interaction among vehicles 141, 142 and 143 in the traffic image according to a car-following theory, so as to find at least one outlier vehicle (e.g., the vehicle 142) from the vehicles 141, 142 and 143 and to select the outlier vehicle as the focus vehicle 142 to be tracked. It should be noted that when the focus vehicle 142 is out of the detection range of the vehicle detector 101, the server 120 automatically calls the next vehicle detector 102 to keep tracking the focus vehicle 142 according to the traveling direction of the focus vehicle 142.

Moreover, the server 120 can recognize types of the vehicles from the traffic image. The server 120 also can collect driving track data of the vehicles from the traffic image.

Then, the server 120 is configured to determine whether a driving behavior of the focus vehicle 142 falls into the abnormal behavior model. When the driving behavior of the focus vehicle 142 falls into the abnormal behavior model as determined, the server 120 determines the focus vehicle 142 is abnormal.

In one embodiment, the abnormal behavior model comprises a violation condition of a plurality of traffic rules. When the server 120 determines that the driving behavior of the focus vehicle 142 violates at least one of the traffic rules (e.g., speeding), the server 120 determines that the focus vehicle is abnormal.

In one embodiment, the abnormal behavior model comprises at least one abnormal track. When the server 120 determines that a driving track of the focus vehicle 142 is different from driving tracks of others of the vehicles, and when the driving track of the focus vehicle 142 meets the at least one abnormal track (e.g., driving in a zigzag pattern), the server 120 determines that the focus vehicle is abnormal.

In one embodiment, the abnormal behavior model includes at least one abnormal speed difference range (e.g., a speed difference over 30 kilometers per hour). The server 120 compares a speed of the focus vehicle 142 with an average speed of others of the vehicles. When a speed difference between the driving speed of the focus vehicle 142 and the average driving speed falls within the at least one abnormal speed difference range, the server 120 determines that the focus vehicle is abnormal.

In one embodiment, the abnormal behavior model includes at least one abnormal distance (e.g., spacing of less than 50 meters). When the server 120 determines that a distance between the focus vehicle 142 and any (e.g., the vehicle 143) of others of the vehicles is less than the at least one abnormality distance, the server 120 determines that the focus vehicle 142 is abnormal.

After the driving behavior of the focus vehicle has fallen into the abnormal behavior model, the server 120 performs an alert processing procedure. For example, after the driving behavior of the focus vehicle 142 falls into the abnormal behavior model, the server 120 performs path prediction on the focus vehicle 142 on the basis of the historical track, the current speed and direction of focus vehicle 142, so as to determine whether the focus vehicle 142 is dangerous to any other vehicle; if so, the server 120 performs the alert processing procedure.

With regard to the alert processing routine, for example, the server 120 may send alert information regarding the focus vehicle 142 to the alert platform 130. Alternatively, the server 120 notifies the radio device and/or display device of the focus vehicle 142 and/or the other vehicles 141 and 143 through a broadcast system and/or display system (not shown) of the vehicle detector 101, or notifies the radio device and/or display device of the focus vehicle 142 and/or the other vehicles 141 and 143 through via the nearest broadcast system and/or display system on the road (not shown). Those with ordinary skill in the art may flexibly design the alert manner depending on the desired application.

FIG. 1B is a block diagram of a system 100B for detecting a dangerous vehicle according to one embodiment of the present disclosure. The system 100B in structure is substantially the same as the system 100A except that FIG. 1B has no lane line 110 as shown in FIG. 1A, thus, are not repeated herein. No matter whether the lane line exists, the system in the present disclosure can detect the dangerous vehicle.

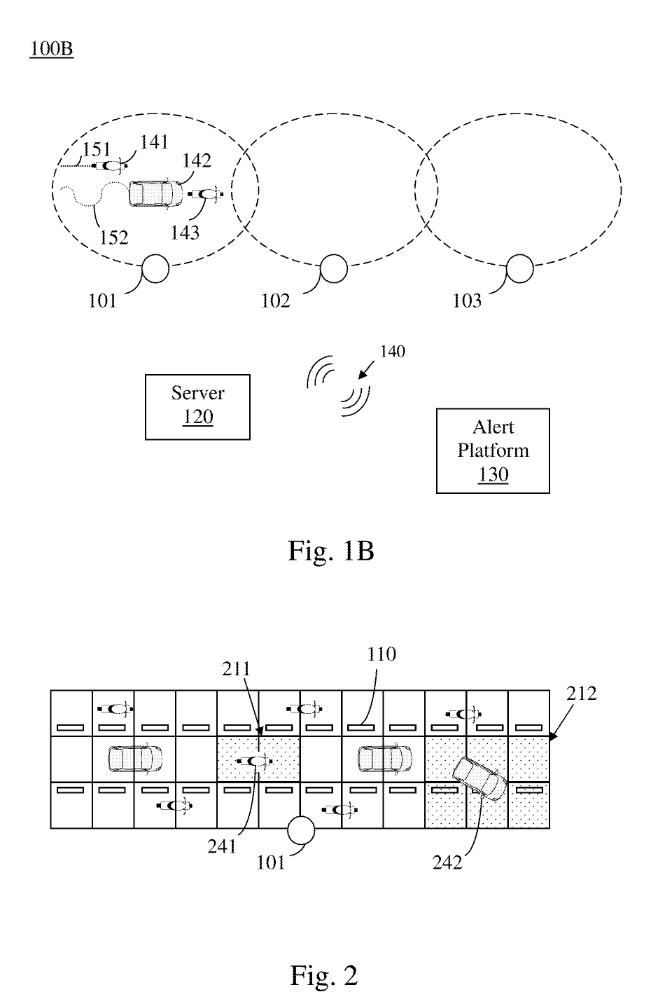

FIG. 2 is a schematic diagram of a focus area according to one embodiment of the present disclosure. As shown in FIGS. 1A and 2, the server is configured to infer an interaction among vehicles in the traffic image according to a car-following theory, so as to find vehicles 241 and 242 and to select the outlier vehicle as focus vehicles to be tracked. For example, the vehicle 241 is the outlier at the vehicle speed (e.g., its vehicle speed dramatically over the average speed) and therefore the vehicle 242 is the outlier away from the track of the other vehicles. The server 120 determines the size and the moving direction of focus areas 211 and 212 surroundings the focus vehicle 241 and 242 required to be detected according to the direction, the speed and the positions of the focus vehicles 241 and 242, so as to tracks focus vehicles 241 and 242 effectively through the dynamic focus areas 211 and 212.

For example, the server 120 determines the dynamic movement directions of the focus areas 211 and 212 after determining the potential focus vehicles 241 and 242 according to the vehicle direction. The server 120 adjusts the sizes of the focus areas 211 and 212 according to the vehicle speed and the positions.

It should be understood that the above-mentioned car-following theory uses dynamic methods to study the vehicle lined up in the lane; the rear vehicle maintains a certain safety distance with the front vehicle, and often changes the driving speed as the front vehicle. The state of the rear vehicle following the front vehicle is expressed in mathematical terms and clarified as the car-following theory.

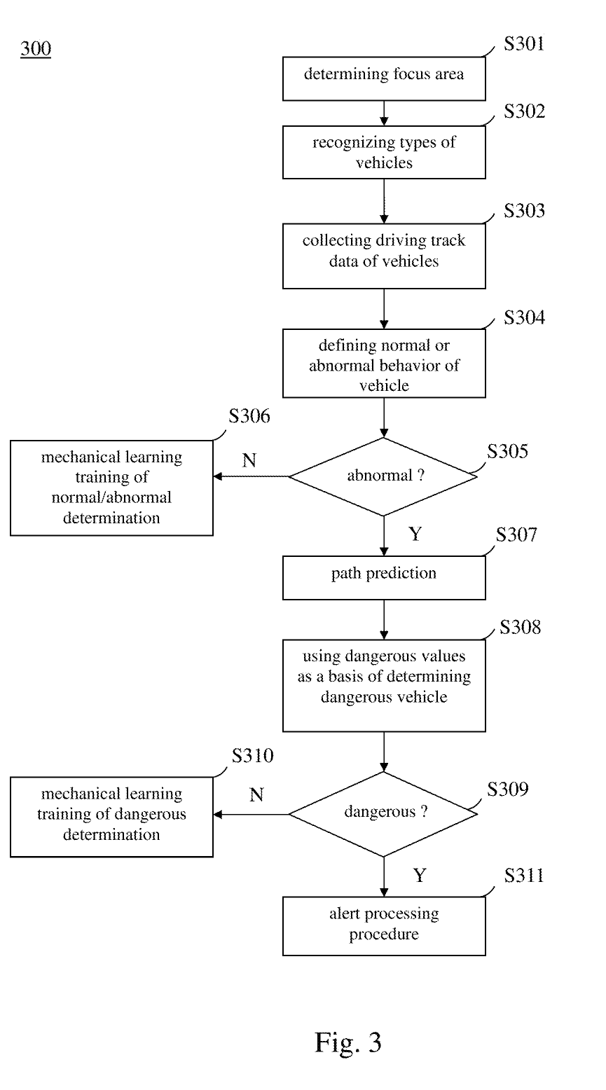

For a more complete understanding of a method performed by the system 100A and/or 100B, referring FIGS. 1A, 1B, 2 and 3, FIG. 3 is a flow chart of a method 300 for detecting a dangerous vehicle according to one embodiment of the present disclosure. As shown in FIG. 3, the method 300 includes operations S301-S311. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently. For example, operations S307-S309 may be regarded as optional steps, or operations S310 and S311 may be regarded as optional steps.

In the method 300, the vehicle detectors 101, 102 and 103 (e.g., the roadside camera) spaced apart from each other are provided, and each vehicle detector configured to obtain a traffic image; the server 120 is configured to infer an interaction among vehicles 141, 142 and 143 in the traffic image according to a car-following theory, so as to find at least one outlier vehicle from the vehicles and to select the outlier vehicle as a focus vehicle (e.g., the vehicle 142) to be tracked, and the server 120 is configured to determine whether a driving behavior of the focus vehicle 142 falls into an abnormal behavior model.

Specifically, in operation S301, the server 120 determines a size and a moving direction of focus area surroundings the focus vehicle 142 required to be detected according to a direction, a speed and a position of the focus vehicle 142. In operation S302, the server 120 recognizes types of the vehicles 141, 142 and 143 from the traffic image. In operation S303, the server 120 collects driving track data of the vehicles from the traffic image. In operation S304, the server 120 defines normal or abnormal behavior of vehicle as a basis of establishing an abnormal behavior model.

Then, in operation S305, the server 120 determines whether a driving behavior of the focus vehicle 142 falls into the abnormal behavior model. When the driving behavior of the focus vehicle 142 does not fall into the abnormal behavior model, in operation S306, the server 120 executes the mechanical learning training of the normal/abnormal determination accordingly.

In one embodiment, the abnormal behavior model comprises a violation condition of a plurality of traffic rules. In operation S305, when the server 120 determines that the driving behavior of the focus vehicle 142 violates at least one of the traffic rules (e.g., speeding), the server 120 determines that the focus vehicle is abnormal.

In one embodiment, the abnormal behavior model comprises at least one abnormal track. In operation S305, when the server 120 determines that a driving track of the focus vehicle 142 is different from driving tracks of others of the vehicles, and when the driving track of the focus vehicle 142 meets the at least one abnormal track (e.g., driving in a zigzag pattern), the server 120 determines that the focus vehicle is abnormal.

In one embodiment, the abnormal behavior model includes at least one abnormal speed difference range (e.g., a speed difference over 30 kilometers per hour). In operation S305, the server 120 compares a speed of the focus vehicle 142 with an average speed of others of the vehicles. When a speed difference between the driving speed of the focus vehicle 142 and the average driving speed falls within the at least one abnormal speed difference range, the server 120 determines that the focus vehicle is abnormal.

In one embodiment, the abnormal behavior model includes at least one abnormal distance (e.g., spacing of less than 50 meters). In operation S305, when the server 120 determines that a distance between the focus vehicle 142 and any (e.g., the vehicle 143) of others of the vehicles is less than the at least one abnormality distance, the server 120 determines that the focus vehicle 142 is abnormal.

After the driving behavior of the focus vehicle 142 falls into the abnormal behavior model, in operation S307, the server 120 performs path prediction on the focus vehicle 142. In operation S308, the server 120 uses dangerous values as a basis of determining the dangerous vehicle. Accordingly, in operation S309, the server 120 determines whether the focus vehicle 142 is dangerous to any other vehicle.

For an instance of the dangerous value, when that the driving behavior of the focus vehicle 142 violates at least one of the traffic rules (e.g., speeding), the dangerous value may be a speed limit plus 10 kilometers per hour. For another instance, when the driving track of the focus vehicle 142 meets the at least one abnormal track (e.g., driving in a zigzag pattern), the dangerous value may indicates the driving track across the lane line 110. For yet another instance, when the speed difference between the driving speed of the focus vehicle 142 and the average driving speed falls within the abnormal speed difference range (e.g., a speed difference over 30 kilometers per hour), the dangerous value may be the speed difference over 40 kilometers per hour. For still yet another instance, When the server 120 determines that a distance between the focus vehicle 142 and any (e.g., the vehicle 143) of others of the vehicles is less than the (e.g., spacing of less than 50 meters) the dangerous value may be the spacing of less than 2 meters. In view of above, dangerous values can be upper/lower limits of the range of anomalies defined in the abnormal behavior model. Those with ordinary skill in the art may flexibly adjust dangerous values depending on the desired application.

When the focus vehicle 142 is not dangerous to other vehicles, in operation S310, the server 120 executes the mechanical learning training of the dangerous determination accordingly. On the contrary, when the focus vehicle 142 is not dangerous to any other vehicle, in operation S311, the server 120 performs an alert processing procedure. In another embodiment, operations S307-S311 can be omitted, and therefore when the server 120 determines that the focus vehicle 142 is abnormal in operation S305, the server 120 performs the alert processing procedure directly in operation S311. Those with ordinary skill in the art may flexibly choose operations depending on the desired application.

In view of above, the system 100A and 100B and the method 300 for detecting the dangerous vehicle provide the vehicle dynamic focus image recognition, so as to accomplish accurate and comprehensive consideration of the warning mode.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A system for detecting dangerous vehicle, the system comprising:
a plurality of vehicle detectors spaced apart from each other, and each vehicle detector configured to obtain a traffic image; and
a server communicated with the vehicle detectors, and the server configured to infer an interaction among vehicles in the traffic image according to a car-following theory, so as to find at least one outlier vehicle from the vehicles and to select the outlier vehicle as a focus vehicle to be tracked, and the server configured to determine whether a driving behavior of the focus vehicle falls into an abnormal behavior model.

2. The system of claim 1, wherein the server determines a size and a moving direction of a focus area surroundings the focus vehicle required to be detected according to a direction, a speed and a position of the focus vehicle.

3. The system of claim 1, wherein the server recognizes types of the vehicles from the traffic image.

4. The system of claim 1, wherein the server collects driving track data of the vehicles from the traffic image.

5. The system of claim 1, wherein the abnormal behavior model comprises a violation condition of a plurality of traffic rules, and when the server determines that the driving behavior of the focus vehicle violates at least one of the traffic rules, the server determines that the focus vehicle is abnormal.

6. The system of claim 1, wherein the abnormal behavior model comprises at least one abnormal track, when the server determines that a driving track of the focus vehicle is different from driving tracks of others of the vehicles, and when the driving track of the focus vehicle meets the at least one abnormal track, the server determines that the focus vehicle is abnormal.

7. The system of claim 1, wherein the abnormal behavior model includes at least one abnormal speed difference range, the server compares a speed of the focus vehicle with an average speed of others of the vehicles, and when a speed difference between the driving speed of the focus vehicle and the average driving speed falls within the at least one abnormal speed difference range, the server determines that the focus vehicle is abnormal.

8. The system of claim 1, wherein the abnormal behavior model includes at least one abnormal distance, and when the server determines that a distance between the focus vehicle and any of others of the vehicles is less than the at least one abnormality distance, the server determines that the focus vehicle is abnormal.

9. The system of claim 1, wherein the server performs an alert processing procedure after the driving behavior of the focus vehicle has fallen into the abnormal behavior model.

10. The system of claim 1, wherein each of the vehicle detectors is a roadside camera.

11. A method for detecting a dangerous vehicle, the method comprising steps of:
providing a plurality of vehicle detectors spaced apart from each other, and each vehicle detector configured to obtain a traffic image; and
using a server configured to infer an interaction among vehicles in the traffic image according to a car-following theory, so as to find at least one outlier vehicle from the vehicles and to select the outlier vehicle as a focus vehicle to be tracked, and the server configured to determine whether a driving behavior of the focus vehicle falls into an abnormal behavior model.

12. The method of claim 1, further comprising:
using the server to determine a size and a moving direction of a focus area surroundings the focus vehicle required to be detected according to a direction, a speed and a position of the focus vehicle.

13. The method of claim 11, further comprising:
using the server to recognize types of the vehicles from the traffic image.

14. The method of claim 11, further comprising:
using the server to collect driving track data of the vehicles from the traffic image.

15. The method of claim 11, wherein the abnormal behavior model comprises a violation condition of a plurality of traffic rules, and the method further comprises:
when the server determines that the driving behavior of the focus vehicle violates at least one of the traffic rules, determining that the focus vehicle is abnormal by using the server.

16. The method of claim 11, wherein the abnormal behavior model comprises at least one abnormal track, and the method further comprises:
when the server determines that a driving track of the focus vehicle is different from driving tracks of others of the vehicles, and when the driving track of the focus vehicle meets the at least one abnormal track, determining that the focus vehicle is abnormal by using the server.

17. The method of claim 11, wherein the abnormal behavior model includes at least one abnormal speed difference range, and the method further comprises:
using the server compares a speed of the focus vehicle with an average speed of others of the vehicles; and
when a speed difference between the driving speed of the focus vehicle and the average driving speed falls within the at least one abnormal speed difference range, determining that the focus vehicle is abnormal by using the server.

18. The method of claim 11, wherein the abnormal behavior model includes at least one abnormal distance, and the method further comprises:
when the server determines that a distance between the focus vehicle and any of others of the vehicles is less than the at least one abnormality distance, the server determines that the focus vehicle is abnormal.

19. The method of claim 11, further comprising:
using the server performs an alert processing procedure after the driving behavior of the focus vehicle has fallen into the abnormal behavior model.

20. The method of claim 11, wherein each of the vehicle detectors is a roadside camera.
